(19) United States
(12) Patent Application Publication
(10) Pub. No.: US 2020/0392397 A1
(43) Pub. Date: Dec. 17, 2020

(54) CROSSLINKABLE FRICTION REDUCER

(71) Applicant: TouGas Oilfield Solutions GmbH, Frankfurt am Main (DE)

(72) Inventors: Fatima Dugonjic-Bilic, Offenbach (DE); Benjamin Gerlach, Aschaffenburg (DE); Marita Neuber, Dreieich (DE)

(21) Appl. No.: 16/954,994

(22) PCT Filed: Dec. 17, 2018
(86) PCT No.: PCT/EP2018/085290

§ 371 Date: Jun. 17, 2020

(30) Foreign Application Priority Data
Dec. 20, 2017 (EP) 17002039.0

(51) Int. Cl. C09K 8/68; C09K 8/80; E21B 43/267

(52) U.S. Cl. CPC C09K 8/685; C09K 2208/28; E21B 43/267; C09K 8/80

(57) ABSTRACT

The present invention relates to the use of a water soluble synthetic copolymer comprising acrylamide monomer units and additionally monomer units bearing phosphonic groups, said copolymer having not more than 5 wt.-% of monomer units containing carboxylic groups, as friction reducer for subterranean treatment and said water soluble synthetic copolymer being cross-linkable using polyvalent cations.

The resources for fossil fuels are highly exploited and also limited. With new and improved technologies, these resources for oil and gas can be further exploited and unconventional reservoirs can be accessed. With the increasingly challenging conditions for the oil and gas production the requirements for the equipment and the chemicals also become more and more demanding.

Several techniques are used to increase oil and gas production from formations with low permeability or from exploited oil and gas field, as hydraulic fracturing, acidizing or enhanced oil recovery.

Hydraulic fracturing is applied to increase the permeability of the formation for oil and gas by pumping fluid under high pressure into the formation to open fractures already present in the formation and to create new fractures. Once the fractures are enhanced or formed proppants are placed into the fracture to form a proppant pack that prevents the fracture from closing when the hydraulic pressure is release, forming conductive channels through which oil and/or gas from the formation may flow to the production well bore.

During the pumping of the aqueous treatment fluid into the well bore, a considerable amount of energy is lost due to friction between the aqueous treatment fluid and the formation and/or the bore linings. In order to reduce this friction, friction pressure reducing compounds are added to the treatment fluid. Therefore, the treatment fluid can be pumped with reduced horsepower or with the same horsepower larger treatment fluid volumes can be mastered. These types of treatment are often called “slick water fracturing”. They are often applied in the production of shale gas.

At the end of a frac job often the viscosity of the treatment fluid is increased is. Thus, fluid loss into the formation can be reduced and further fractures can be created. Furthermore, viscosified fluids are characterized by superior proppant carrier capability allowing a more precise and predictable proppant placement within the formation.

Water soluble polymers with high molecular weight are typically used as friction reducer in well treatment fluids to alter the rheological properties of the treatment fluid so that the turbulent flow is minimized, thereby reducing the energy for pumping the fluid.

The polymers are typically synthetic polymers, in most instances they are based on acrylamide and mostly contain acrylic acid units besides occasionally other monomers as described for example in U.S. Pat. No. 7,004,254. There a method of treating a subterranean formation is claimed comprising providing an aqueous treatment fluid comprising water, and a friction reducing copolymer consisting essentially of acrylamide in an amount in the range from about 80% to about 90% by weight and acrylic acid in an amount in the range from about 10% to about 20% by weight; and introducing the aqueous treatment fluid into the portion of the subterranean formation.

The friction reducing polymer is typically provided as a water in oil emulsion—also called inverse emulsion—with the water-soluble polymer being dissolved in an aqueous phase that is finely dispersed in a water immiscible organic phase as external fluid. The emulsion may contain one or more surfactant to stabilize the water droplets. The water in oil emulsion is a liquid that can be easily handled and gauged. In contrast to handling of powdery solids, there is no dust formation during handling and no risk that slippery deposits form when the dust settles and comes into contact with humid air or water.

Hydration of a polymer provided in a water in oil emulsion—often also called inversion of the polymer emulsion—is much faster compared to hydration of a dry polymer powder. No presolution, preparation of a stock solution or aging of the polymer solution is required. There is no risk that gel lumps or fish eyes form during dissolution of the polymer and no filtration of the polymer solution is required to remove undissolved or incomplete hydrated gel particles.

The polymer of a water in oil emulsion is easily hydrated by mixing the emulsion with an aqueous liquid while applying sufficient shear or using a surfactant that helps to break the emulsion to release the polymer from the emulsion. This inverting surfactant can be part of the aqueous liquid but also be an additional ingredient of the water in oil polymer emulsion.

The addition of surfactant to the emulsion that helps to enhance inversion is well known. For example, the incorporation of ethoxylated fatty alcohols to inverse emulsion is already described in 1971 in U.S. Pat. No. 3,624,019.

U.S. Pat. No. 9,315,722 claims that inversion and performance of friction reducer properties can be improved by using a water in oil polymer emulsion comprising the friction reducing polymer, an inverting surfactant and in addition at least 3% by weight of salt.

Partially hydrolysed polyacrylamide friction reducer show only reduced performance in aqueous fluids containing polyvalent cations. These cations interact with the carboxylic groups of the polymers leading to sparingly soluble compounds and often to precipitation of the polymer. These precipitates may block the formation entailing reduced or even not any productivity of the well. This means, that conventional friction reducing polymers are not or only limited compatible when untreated water like sea water, formation water or produced water containing divalent cations like Ca²⁺ and Mg²⁺ is used as aqueous fluid.

To overcome these disadvantages the use of a polymer composition comprising a complexing agent and a friction reducing polymer is described US 2009/0298721. The complexing agent prevents and/or reduces undesirable interaction between polyvalent cations and the friction reducing polymer and therefore improves the performance of the polymer.

Another approach is described in U.S. Pat. No. 7,504,366, where friction reducing polymers are described comprising acrylamide and an acrylic acid ester. These polymers do not bear ionic groups, therefore the damaging interaction of polyvalent cations with ionic groups of typical friction reducer copolymer consisting of acrylamide and acrylic acid can be avoided.

Friction reducing polymers effectively reduce pumping pressure already at low concentrations. Typically, their concentrations vary from about 0.01 to 4% by weight related to the treatment fluid or from about 0.2 to 10 gpt (gallons per thousand gallons) when friction reducers are used in liquid form as water in oil emulsion. At low concentrations, the treatment fluid shows the same or only slightly higher viscosity compared to the polymer free fluid.

Reduced friction pressure allows high pumping rates of the treatment fluid. Propping agent such as sand or other hard material—often called proppants—are transported into the formation due to the high flow rate of the treatment fluid. Proppant transport by high flow rate however is limited to proppants with low density, low proppant concentration and/or small proppant diameter. When there is a need to increase proppant carrier capability, further measures are necessary.

By increasing the polymer concentration, the viscosity of the treatment fluid also increases. This effect can sometimes be sufficient to transport and place proppants into the formed cracks. However, the proppant carrier capability of such a linear gels of conventional friction reducer polymer is also limited. Furthermore, the high polymer concentration for the highly viscous linear gel may easily lead to formation damage.

When polymer chains are being crosslinked to form a three dimensional hydrogel the viscosity of the fluid increased significantly even at much lower polymer concentrations compared to linear gels with the same viscosity. In addition, the crosslinked gel is much more supporting for proppant transport and allows the use of higher a proppant load and/or of higher strength proppants with higher density.

Unfortunately, due to the structure of conventional partially hydrolysed polyacrylamide friction reducers, they do not form stable crosslinked gels, especially at elevated temperatures or in presence of salts.

Therefore, for crosslinked gels mainly natural based polysaccharides or modified polysaccharides are used, for instance, suitable hydratable polysaccharides including starch or its derivatives, cellulosic derivatives, guar gums or its derivatives, preferably hydroxyalkyl guar, carboxyalkyl guar, and carboxyalkyl hydroxyalkyl guar.

For crosslinking of the polymer chains to form a hydrogel, that is a three-dimensional network of extremely high molecular weight, typically polyvalent cations of group IIIA, IVB, VB, VIB, VIIB and/or VIIIB of the periodic table of the elements are used as crosslinking compound, preferred are compounds of boron, zirconium, titanium, aluminum or chromium, for both synthetic polymers and natural polymers.

Naturally based polymers may be suitable for the preparation of crosslinked gels, however, they perform only poorly as friction reducer.

That means that during a frac job the fluid treatment composition has to be changed to achieve the best performance. This requires much more detailed planning of the schedule of the frac jobs and may lead to interruption or shutdown of the job when switching from one fluid to the other one. The requirements regarding equipment for proper handling of the different polymers for friction reduction performance or for crosslinking purposes are different, all this leading to greater expense for planning and logistics for equipment and raw materials.

Therefore, there is a need for friction reducer polymers, which are compatible with untreated water like sea water, formation water or produced water containing polyvalent cations and can be crosslinked to form a hydrogel for improved proppant carrier capability.

Surprisingly it was found that high molecular weight copolymers based on acrylamide comprising monomer units bearing phosphonic groups and not more than 5 wt.-% of monomer units containing carboxylic groups fulfil this requirement. In the beginning of a frac job when large quantities of the treatment fluid are pumped the polymer functions as a friction reducer and reduces the power to pump the fluid. At a later time of the treatment, when proppants are pumped to keep the created fractures open, the polymer is crosslinked by adding cations capable to crosslink the polymer chains to the fluid to create a fluid with increased viscosity and proppant carrier capability. Thus, the instant copolymers provide—beside friction reducing properties—the possibility to form cross-linked hydrogels.

### DETAILED DESCRIPTION

Therefore, the present invention relates to the use of a water soluble synthetic copolymer comprising acrylamide monomer units and additionally monomer units bearing phosphonic groups, said copolymer having not more than 5 wt.-% of monomer units containing carboxylic groups, as friction reducer for subterranean treatment and said water soluble synthetic copolymer being cross-linkable using polyvalent cations.

The present invention relates also to a method for subterranean treatment comprising the steps of:
(i) providing a treatment fluid containing at least
   (I) water,
   (II) a water soluble synthetic copolymer comprising acrylamide monomer units and additionally monomer units bearing phosphonic groups, said copolymer having not more than 5 wt.-% of monomer units containing carboxylic groups,
(ii) adding optionally a breaker composition
(iii) pumping the treatment fluid into the formation,
(iv) adding polyvalent cation from the beginning of step (iii) or at a later time during step (iii), said polyvalent cation crosslinks the polymer chains and thereby increases the viscosity of the treatment fluid by forming a hydrogel,
(v) adding proppants to the treatment fluid from the beginning of step (iii) or at a later time during step (iii) or from the beginning of step (iv) or at a later time during step (iv).

The pumping in and during steps (ii) to (iv) is typically performed until a pre-set desired pressure is reached. Such pressure, as well as the duration of the pumping, depends on the individual formation and/or equipment being used.

The instant invention provides—beside friction reducing properties—the possibility to form cross-linked hydrogels to allow for more efficient use of proppants, while there is no need to change from one treatment fluid to a further, different treatment fluid. Prior to the instant invention, individual treatments and fluid were employed because there was no system available providing friction reducing properties and allowing for the formation of cross-linked hydrogels, in particular when used in combination with proppant.

Friction Reducing Polymer

According to the instant invention, the water-soluble polymer is a polymer acting as friction reducing agent. The water-soluble polymer used in the invention is a synthetic polymer, in particular such synthetic polymer material are synthetic polyacrylamide based polymers, copolymers or terpolymers.

Preferably, the synthetic polymer used in the instant invention is a synthetic polymer comprising:
(I) at least structural units of formula (I)

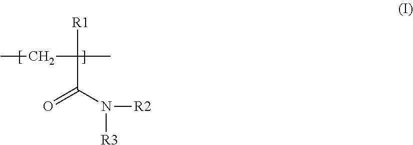

wherein
R1, R2 and R3 independently are hydrogen or C₁-C₆-alkyl,
(II) from 0 to 95% by weight structural units of formula (II)

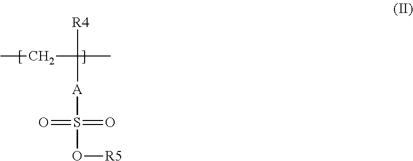

wherein
R4 is hydrogen or C₁-C₆-alkyl,
R5 is hydrogen, a cation of an alkaline metal, of an earth alkaline metal, of ammonia and/or of an organic amine,
A is a covalent C—S bond or a two-valent organic bridging group,
(III) from 0 to 5% by weight structural units of formula (III)

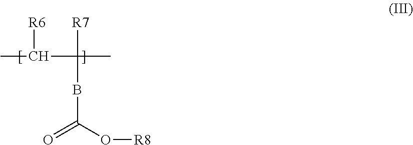

wherein
B is a covalent C—C bond or a two-valent organic bridging group
R6 and R7 are independently of one another hydrogen, C₁-C₆-alkyl, —COOR₉ or —CH₂—COOR₉, with R₉ being hydrogen, a cation of an alkaline metal, of an earth alkaline metal, of ammonia and/or of an organic amine,
R8 is hydrogen, a cation of an alkaline metal, of an earth alkaline metal, of ammonia and/or of an organic amine, or is C₁-C₆-alkyl, a group —CₙH₂ₙ—OH with n being an integer between 2 and 6, preferably 2, or is a group —CₒH₂ₒ—NR10R11, with o being an integer between 2 and 6, preferably 2, and
R10 and R11 are independently of one another hydrogen or C₁-C₆-alkyl, preferably hydrogen,
(IV) from 0 to 50% by weight structural units of formula (IV)

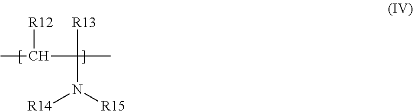

wherein
R12 and R13 are independently of one another hydrogen, C₁-C₆-alkyl, —COOR16 or —CH₂—COOR16, with
R16 being hydrogen, a cation of an alkaline metal, of an earth alkaline metal, of ammonia and/or of an organic amine,
R14 is hydrogen or, C₁-C₆-alkyl, and
R15 is —COH, —CO—C₁-C₆-alkyl or
R14 and R15 together with the nitrogen atom to which they are attached form a heterocyclic group with 4 to 6 ring atoms, preferably a pyridine ring, a pyrrolidone ring or a caprolactame ring,
(V) from 0.1 to 20% by weight structural units of formula (V)

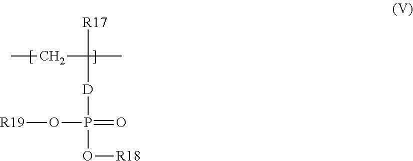

wherein
D is a covalent C—P bond or a two-valent organic bridging group
R17 is hydrogen or, C₁-C₆-alkyl, and
R18 and R19 are independently of one another hydrogen, a cation of an alkaline metal, of an earth alkaline metal, of ammonia and/or of an organic amine,
B is a covalent C—P bond or a two-valent organic bridging group,
(VI) optionally further copolymerisable monomers, such copolymerisable monomers being present from 0 to 20% by weight structural units,

with the proviso that the percentage of the structural units of formulae (I) to (VI), preferably the structural units of formulae (I) to (V), refer to the total mass of the copolymer and the percentage of the structural units of formulae (I) to (VI), preferably the structural units of formulae (I) to (V), amounts to 100%.

The C₁-C₆-alkyl groups being present in the above formulae (I) to (V) are independently of each other and may be straight chain or branched. Examples of alkyl groups are methyl, ethyl, n-propyl, iso-propyl, n-butyl, sec.-butyl, tert.-butyl, n-pentyl or n-hexyl. Ethyl and especially methyl are preferred.

The group A may be a C—S-covalent bond or a two-valent organic group. Examples thereof are C₁-C₆-alkylene groups or —CO—C₁-C₆-alkylene groups. The alkylene groups may be straight chain or branched. Examples of A groups are —CₚH₂ₚ— groups or —CO—NH—CₚH₂ₚ— groups, with p being an integer between 1 and 6. —CO—NH—C(CH₃)₂—CH₂— or a C—S-covalent bond is a preferred group A.

The group B in formula (III) may be a C—C-covalent bond or a two-valent organic group. Examples thereof are C₁-C₆-alkylene groups. These groups may be straight chain or branched. Examples of alkylene groups are —C_{q}H_{2q}— groups, with q being an integer between 1 and 6. Methylene or a C—C-covalent bond is a preferred group B.

The group D in formula (V) may be a C—P-covalent bond or a two-valent organic group. Examples thereof are C₁-C₆-alkylene groups. These groups may be straight chain or branched. Examples of alkylene groups are —C_{q}H_{2q}— groups, with q being an integer between 1 and 6. Methylene or a C—P-covalent bond is a preferred group D.

The structural units of formula (I) are derived from an ethylenically unsaturated carboxylic acid amide selected from the group of acrylamide, methacrylamide and/or their N—C₁-C₆-alkyl derivatives or N,N—C₁-C₆-dialkyl derivatives.

Preferred polymers used in the instant invention further contain structural units of formula (II) to (V) which are derived from an ethylenically unsaturated sulfonic acid and/or its alkaline metal salts and/or their ammonium salts, and/or an ethylenically unsaturated phosphonic acid and/or its alkaline metal salts and/or their ammonium salts, optionally together with further copolymerisable monomers.

Other preferred copolymers used in the instant invention are those, wherein B is a C—P covalent bond or a —C_{q}H_{2q}— group with q being an integer between 1 and 6, preferably 1, and/or wherein A is a C—S covalent bond or a —CO—NH—CₚH₂ₚ— group with p being an integer between 1 and 6, preferably between 2 and 4, B being most preferably a group —CO—NH—C(CH₃)₂—CH₂—.

Also preferably applied are copolymers with structural units of the formula (II) derived from vinylsulfonic acid, 2-acrylamido-2-methylpropane sulfonic acid, 2-methacrylamido-2-methylpropane sulfonic acid, styrene sulfonic acid and/or their alkaline metal salts and/or their ammonium salts. Especially preferred are structural units of the formula (II) derived from vinylsulfonic acid and/or 2-acrylamido-2-methylpropane sulfonic acid and/or from their alkaline metal salts and/or from their ammonium salts.

The ethylenically unsaturated carboxylic acids of the formula (III) are preferably acrylic acid, methacrylic acid, fumaric acid, maleic acid, itaconic acid and/or crotonic acid as well as their alkaline metal salts and/or their ammonium salts. The alkylesters of ethylenically unsaturated carboxylic acids are preferably alkylesters of acrylic acid, methacrylic acid, fumaric acid, maleic acid, itaconic acid and/or crotonic acid. Especially preferred are alkylesters with 1 to 6 carbon atoms.

The oxyalkylesters of an ethylenically unsaturated carboxylic acids of the formula (III) are preferably 2-hydroxyethylester of acrylic acid, methacrylic acid, fumaric acid, maleic acid, itaconic acid and/or crotonic acid.

The ester of ethylenically unsaturated carboxylic acid of the formula (III) with N-dialkylalkanolamine is preferably N,N-dimethylethanolamine methacrylate, its salt or quaternary ammonium product.

Further preferably applied copolymers with structural units of the formula (IV) are derived from N-vinylamides. The N-vinylamide is preferably N-vinylformamide, N-vinylacetamide, N-vinyl-N-methylacetamide, or N-vinylamide comprising cyclic N-vinylamide groups, preferably derived from N-vinylpyrrolidone, N-vinylcaprolactame or N-vinylpyridine.

Preferably applied are copolymers with structural units of the formula (V) are derived from vinylphosphonic acid and/or its alkaline metal salts and/or its ammonium salts, and/or allylphosphonic acid and/or its alkaline metal salts and/or its ammonium salts.

Preferred copolymers used in the instant invention are those, wherein R₁, R₂, R₃, R₄, R₁₀, R₁₁, R₁₄, and R₁₇ are independently of one another hydrogen or methyl or wherein R₅, R₉, R₁₆, R₁₈ and R₁₉ are independently of one another hydrogen or a cation of an alkali metal, of an earth alkaline metal, of ammonia or of an organic amine.

Still other preferred copolymers used in the instant invention are those, wherein R₆ and R₁₂ is hydrogen and R₇ and R₁₃ is hydrogen or methyl, or wherein R₆ is —COOR₉ and R₇ is hydrogen or wherein R₆ is hydrogen and R₇ is —CH₂—COOR₉ or wherein R₁₂ is hydrogen and R₁₃ is hydrogen or methyl, or wherein R₁₂ is —COOR₁₆ and R₁₃ is hydrogen or wherein R₁₂ is hydrogen and R₁₃ is —CH₂—COOR₁₆.

In particular, preferred are water soluble synthetic copolymers material which are selected from the group consisting of polymers containing:
(I) 10 to 90% by weight of structural formula I, preferred from 20 to 70% by weight,
(II) 1 to 95% by weight of structural formula II, preferred from 10 to 60% by weight,
(III) 0 to 2% by weight of structural formula III, preferred from 0 to 1% by weight,
(IV) 0 to 50% by weight of structural formula IV, preferred from 0 to 20% by weight,
(V) 0.1 to 20% by weight of structural formula V, preferred from 0.1 to 10% by weight,

referred to the total mass of the polymer, with the proviso that the percentage of the structural units of formulae (I) to (V) refer to the total mass of the copolymer and the percentage of the structural units of formulae (I) to (V) amounts to 100%.

Preferably, the water-soluble friction reducing polymer has a high molecular weight. The average molecular weight of the copolymers used according to the invention is higher than 1,000,000 Dalton, preferably higher than 3,000,000 Dalton.

The average molecular weight can be determined via gel permeation chromatography (GPC). Commercially available polymers, e.g. from acrylamide with molecular weight of 1,140,000 Dalton and 5,550,000 Dalton, can be used as standards. For separation of the sample a column consisting of a polyhydroxymethacrylate copolymer network with a pore volume of 30,000 Angstrom (Å) can be used.

The K value according to Fikentscher serves as indicator for the average molecular weight of the copolymers according to the invention. To determine the K value, the copolymer is dissolved in a certain concentration (generally 0.5 weight %, in the instant invention 0.1 weight %) and the efflux time at 30° C. is determined by means of an Ubbelohde capillary viscometer. This value gives the absolute viscosity of the solution (η_{c}). The absolute viscosity of the solvent is ηₒ. The ratio of the two absolute viscosities gives the relative viscosity ηᵣₑₗ

ηᵣₑₗ=η_{c}/ηₒ

From the relative viscosity, the K value can be determined as a function of the concentration c by means of the following equations:

Log ηᵣₑₗ=[(75k²/(1+1.5kc)+k]c

k=K/1000

The K value of the copolymers used according to the invention is higher than 300 determined as 0.1 weight % copolymer concentration in deionized water, preferably is higher than 350.

The concentration of the polymer is typically from 0.001 to 10%. by weight, preferred from 0.005 to 5% by weight and most preferred from 0.01 to 2% by weight, referred to the aqueous polymer solution. The term “water-soluble” is thereby met when the aforementioned concentration of the polymer in water is obtained.

When the polymer is crosslinked, the polymer concentration typically ranges from 0.01 to 10% by weight, preferred from 0.1 to 5%, most preferred from 0.2 to 2%, referred to the total mass of aqueous polymer solution.

The polymers can be synthesized by various technologies, e.g. by inverse emulsion polymerisation or gel polymerisation with inverse emulsion polymerization as the preferred technology.

Inverse Emulsion

In embodiments where a particular friction reducing polymer of the present invention is suspended in water in oil copolymer emulsion, the water in oil copolymer emulsion may comprise water, a water-immiscible liquid, an emulsifier, and a friction reducing copolymer of the present invention. Suitable water in oil polymer emulsions further may comprise further additives like salts, and inverters.

The water present in the water in oil polymer emulsions generally includes freshwater, but saltwater or combinations with saltwater also may be used. Generally, the water used may be from any source, provided that it does not contain an excess of compounds that may adversely affect other components in the water in oil polymer emulsion. In some embodiments, the water may be present in the water in oil polymer emulsion in an amount in the range of from about 25% to about 50% by weight of the emulsion.

Suitable water-immiscible liquids may include, but are not limited to, water-immiscible solvents, such as paraffin hydrocarbons, napthene hydrocarbons, aromatic hydrocarbons, and mixtures thereof. The paraffin hydrocarbons may be saturated, linear, or branched paraffin hydrocarbons. Examples of suitable aromatic hydrocarbons include, but are not limited to, toluene and xylene. The water-immiscible liquid may be present in the water in oil polymer emulsion in an amount sufficient to form a stable emulsion. In some embodiments, the water-immiscible liquid may be present in the water in oil polymer emulsions in an amount in the range of from about 15% to about 40% by weight.

Emulsifiers should be present in the water in oil polymer emulsion, among other things, to lower the interfacial tension between the water and the water-immiscible liquid so as to facilitate the formation of an water in oil polymer emulsion. The emulsifier should be present in an amount sufficient to provide the desired stable water in oil polymer emulsion. In some embodiments, the emulsifier may be present in an amount in the range of from about 0.5% to about 6% by weight of the emulsion.

The friction-reducing copolymers of the present invention that may be present in the water in oil polymer emulsions are described above. The friction-reducing copolymer should be present in the water in oil polymer emulsion in an amount that does not undesirably impact the emulsion's stability. In some embodiments, the friction-reducing copolymer may be present in an amount in the range of from about 20% to about 40% by weight of the emulsion.

In some embodiments, the water in oil polymer emulsions further may comprise a salt. Among other things, the salt may be present, among other things, to add stability to the emulsion and/or reduce the viscosity of the emulsion. Examples of suitable salts, include, but are not limited to, ammonium chloride, potassium chloride, sodium chloride, ammonium sulfate, and mixtures thereof. In some embodiments, the salt may be present in the water in oil polymer emulsions in an amount in the range of from about 0.5% to about 2.5% by weight of the emulsion.

In some embodiments, the water in oil polymer emulsions further may comprise an inverter. Among other things, the inverter may facilitate the inverting of the emulsion upon addition to the aqueous treatment fluids of the present invention. Upon addition to the aqueous treatment fluid, the emulsion should invert, releasing the copolymer into the aqueous treatment fluid. Examples of suitable inverters include, but are not limited to, ethoxylated alcohols, nonionic surfactant with an HLB of from 12 to 14, and mixtures thereof. The inverter should be present in an amount sufficient to provide the desired inversion of the emulsion upon contact with the water in the aqueous treatment fluid. In some embodiments, the inhibitor may be present in an amount in the range of from about 1% to about 10% by weight of the emulsion.

In some embodiments, emulsion polymerization may be used to prepare a suitable water in oil polymer emulsion that comprises a friction reducing copolymer of the present invention. Suitable emulsion polymerization techniques may have a variety of different initiation temperatures depending on, among other things, the amount and type of initiator used, the amount and type of monomers used, and a number of other factors known to those of ordinary skill in the art.

A variety of different mixtures may be used to prepare an water in oil polymer emulsion comprising a friction reducing copolymer of the present invention. Suitable mixtures may include acrylamide, further monomers, water, a water-immiscible liquid, and an emulsifier. Optionally, the mixture further may comprise an inhibitor, a base (e.g., sodium hydroxide) to neutralize the acidic monomers forming the salt form of the friction reducing copolymer, an activator to initiate polymerization at a lower temperature, and an inverter. Those of ordinary skill in the art, will know the amount and type of components to include in the mixture based on a variety of factors, including the desired molecular weight and composition of the friction reducing copolymer and the desired initiation temperature.

Preparation of Treatment Fluid

A treatment fluid is prepared by dissolving a solid polymer or by diluting a polymer solution or by inverting a water-in-oil polymer emulsion using water or an aqueous solution under appropriate shearing.

The water for preparing the treatment fluid according to this invention can be fresh water, e.g. river water, or natural occurring brines like seawater, formation water, produced water and/or flow back from a well after a stimulation process and mixtures thereof containing different concentrations of salts. In addition, further salts can be added to achieve improved performance of the treatment fluid. Therefore, the water for preparing the polymer solution and the treatment fluid may contain salts comprising mono-, di-, or trivalent cations and or anions, non-limiting examples are lithium, sodium, potassium, strontium, ammonium, calcium, magnesium, barium, boron, aluminium, iron, fluoride, chloride, bromide, sulphate, carbonate, acetate, formate. TDS (total dissolved solids) may range from 50 ppm e.g. for fresh water to 330 000 ppm for high saline brines.

The aqueous solution may further contain water miscible solvent as alcohols, e.g. methanol, ethanol, n- and i-propanol, glycol.

The aqueous polymer solution may further contain additives that are necessary for the treatment. Those additives may include buffer, surfactants, biocides, breaker substances, clay inhibitors and/or corrosion inhibitors.

When water in oil polymer emulsions are used, the presence of an inverting surfactant may facilitate the hydration. When solid polymer powder is used, the polymer solution should be aged to allow complete dissolution and subsequently filtered to remove gel particles.

Crosslinking

To increase the viscosity of the treatment fluid, especially to guarantee appropriate proppant transport, the polymers may also be ionically crosslinked by multivalent metal ions or metal complexes selected from group IIIA, IVB, VB, VIB, IIVB and/or VIIIB of the periodic table of elements, preferably selected form the ions and/or complexes of zirconium, aluminium, titanium, boron, chromium and/or iron. Especially preferred are the ions and/or complexes of zirconium and titanium.

Typically, water-soluble salts of the multivalent metal ions are used. Suitable anions are e.g. halides, especially chloride, sulfate, lactate, citrate or gluconate. Also suitable are complexes of the multivalent metal ions with organic N- and O-compound, e.g. alcohols, di- and triols, mono-, di- and tri-carboxylic acids, mono-, di- and triamines and/or hydroxyalkylamines.

The quantity of transition metal compound for crosslinking the polymers ranges 0.1 to 100% by weight, preferred from 0.5 to 50%, more preferred from 1 to 20% by weight, referred to the total mass of polymer.

The transition metal compounds, e.g. the salts and/or complexes of transition metal cation, are dissolved and/or diluted in water or in a water miscible solvent, and then mixed with the treatment fluid ensure a homogenous distribution of transition metal cation in the solution. The crosslinking of the polymer chains can be retarded or accelerated by adaptation of the stirring speed, pH value, addition of delay agents and/or adjusting the temperature.

The viscosity of the treatment fluid with linear polymer gel prior to crosslinking as provided in step (i) of the instant method typically ranges from about 1 to 50 mPas depending on the conditions of the well treatment.

According to the requirements for placing proppant, the viscosity of the treatment fluid after crosslinking the polymer can be increased from the original viscosity of the linear gel up to several thousand mPas.

Breaking

If necessary, the viscosity of the treatment fluid can be reduced after placing of the proppants to facilitate the removal of the fluid from the bore hole to prevent blockage of the pores and fractures by the highly viscos gel and to minimize formation damage. For the reduction of the viscosity of the fluid typically the water-soluble polymer is degraded by so called breakers. The breakers cleave the high molecular polymer chain into fragments of lower molecular weight and/or deactivate the crosslinking compound.

Solutions of high molecular weight polymers show a high viscosity. Cleaving bonds in the polymer chain gives fragments of lower molecular weight; the viscosity of their solution is reduced. The viscosity of polymer solutions is therefore related to the molecular weight of the polymer.

Analytically the degradation of the polymer chain or network can be characterized by rheological methods in determining the viscosity of the polymer solution. As polymer solutions, typically are non-Newtonian fluids it is important to compare the results only when the methods for the determination of the viscosity were exactly the same.

The polymer degradation can be followed either directly in a rheometer or by determination of the viscosity of the polymer solution before and after breaking treatment.

They degrade the polymer chain by oxidative processes and reduce the viscosity of the fluid. The viscosity of completely degraded polymer solutions is in general <10 mPas, often below <1 mPas.

According to the instant invention, the breaker is selected from organic and/or inorganic peroxides, e.g. persulfates, percarbonates, perborates, diacyl peroxides, peroxy dicarbonates, dialkyl peroxides, alkylhydroperoxides and/or ester of peracids. Oxidizing compound as e.g. chlorites or bromates can also be used as well as aliphatic azo compounds.

Typically, the quantity of the breaker composition ranges from 0.001 to 5% by weight, preferred from 0.01 to 1%, referred to the total mass of aqueous polymer solution.

Proppant

Proppant for use in the subterranean treatment of natural oil or gas reservoirs are known per se (see ‘Modern Fracturing, Enhancing Natural Gas Production, Chapter 8, Proppants and Fracture Conductivity, Page 283’)

The proppant particles mixed with fracturing fluid hold fractures open after a treatment, e.g. hydraulic fracturing treatment. In addition to naturally occurring proppant, such as sand grains, man-made or specially engineered proppants, such as resin-coated sand or high-strength ceramic materials like sintered bauxite, may also be used. Proppant materials are carefully sorted for size and sphericity to provide an efficient conduit for production of fluid from the reservoir to the wellbore.

Typically, for stimulation purposes, two proppant categories are typically used: the aforementioned naturally occurring sands and man-maid proppants which are subdivided into ceramic proppants (sintered bauxite, intermediate strength ceramic proppants and lightweight ceramic proppants), resin-coated proppants and ultra-lightweight proppants.

In general, sands are used as proppant for applications where the closure stress is less than 6000 psi and man-maid proppants at applications with higher formation closure stress. Depending on their physical properties, sands can further be subdivided into groups of excellent, good and substandard grades (API RP 56, 1983, and ISO 13503-2, 2006).

Depending on the viscosity of the frac fluid, sand and/or proppant of different density are applied. In slickwater fracs where no or only low concentration of gellant are present and therefore the viscosity of the frac fluid viscosity is low, typically sand or ultra-lightweight proppants are used. Sands and/or proppants with higher density are preferred for frac jobs with viscosified or crosslinked frac fluids. The sand or proppant loading for slickwater may vary from about 12 gramm/liter to about 359 gramm/liter (about 0.1 ppg to about 3 ppg (ppg=pounds per gallon), which is very low compared to crosslinked fracturing fluids where typically the limit may be as high as about 2400 gramm/liter (about 20 ppg).

The proppant and/or sand size and its distribution directly affect the permeability of the proppant pack after its placement in a hydraulic fracturing treatment and is characterized by the median diameter of the discrete grains. Proppant and/or sand sizes used during stimulation jobs can vary from mesh 8/16 (large proppants), 12/20, 16/30/20/40, 30/50, 40/70 down to 70/140 (small grain size). Typically, sands are screened into different fractions. The size of proppants or sands for single fractured stage depends on the formation, the frac design and fracture width and length to be created during the treatment.

Method

The aqueous treatment fluids of the present invention can be used in any subterranean treatment where the reduction of friction is desired, for example drilling operations, stimulation treatments (e.g., fracturing treatments, acidizing treatments, fracture acidizing treatments), and completion operations.

The present invention provides a method of treating a portion of a subterranean formation, comprising: providing an aqueous treatment fluid of the present invention comprising water and a friction reducing copolymer of the present invention that comprises acrylamide and monomers bearing phosphonic groups and not more than 5 wt.-% of monomers containing carboxylic groups and, if required, polyvalent cations or complexes capable to crosslink the polymer, and introducing the aqueous treatment fluid into the portion of the subterranean formation.

The aqueous treatment fluid may be introduced into the portion of the subterranean formation at a rate and pressure sufficient to create or enhance one or more fractures in the portion of the subterranean formation. The portion of the subterranean formation that the aqueous treatment fluid is introduced in will vary dependent upon the particular subterranean treatment.

The methods of the present invention further may comprise preparing the aqueous treatment fluid. Preparing the aqueous treatment fluid may comprise providing the friction reducing copolymer and combining the friction reducing copolymer with the water to from the aqueous treatment fluid. The friction reducing copolymer may be provided in a solid form, suspended in an oil-external copolymer emulsion, or as a component of an aqueous solution. For example, in certain embodiments, providing the friction reducing copolymer may comprising providing water in oil polymer emulsion that comprises additional water, a water-immiscible liquid, an emulsifier, and the friction reducing copolymer.

The methods of the present invention further employ at least one proppant which is added to the treatment fluid from the beginning of step (iii) or at a later time during step (iii) or from the beginning of step (iv) or at a later time during step (iv).

Test Methods

The following testing methods are used:

The viscosity of polymer solutions or crosslinked gels was determined using a Fann 35 rheometer, an Ubbelohde capillary viscosimeter or 5550 HPHT viscometer from Chandler Engineering.

The Fann 35 rheometer is a Couette type coaxial cylinder rotational viscometer, equipped with R1 rotor sleeve, B1 bob and F1 torsion spring. 120 ml of the sample were poured into the viscometer cup and characterized at 100 rpm and room temperature.

The Chandler 5550 HPHT viscosimeter is a concentric cylinder viscometer equipped with R1 rotor sleeve and B5 bob. 52 ml of the sample were poured into the viscometer cup and characterized at 100 s⁻¹, 25 bar, and 93° C./200° F.

For the Ubbelohde capillary viscosimeter the capillary of appropriate width was chosen, about 30 ml of the sample were filled into the capillary. The capillary was then allowed to adjust temperature to 30° C. for 10 min in a water bath. The time of the defined sample volume for passing through the capillary was taken and then multiplied with the capillary constant to give the viscosity in mPas.

### Abbreviations

HLB HLB-value means the hydrophilic-lipophilic balance of a surfactant and is a measure of the degree to which it is hydrophilic or lipophilic, determined by calculating values for the different regions of the molecule. There are different methods to calculate the HLB-value. The most common results in a ranking of the surfactants between 0 and 20 with 0 corresponds to a completely lipophilic/hydrophobic molecule, and a value of 20 corresponds to a completely hydrophilic/lipophobic molecule. Typically, the suppliers specifies the HLB-value of the surfactant.
ηₒ Viscosity of solvent solution for K value determination
η_{c} Viscosity of copolymer solution for K value determination
ηᵣₑₗ Relation of η_{c} relative to ηₒ
c Concentration of polymer in solution, determination of K value
ppg means pounds (453.59 gramm) per U.S. gallon (3.79 liter)
g means gramm when used alone
gallon means U.S. gallon (3.79 liter)

The following examples illustrate the invention without limiting it.

### Example 1

### Preparation of a Polymer Via Inverse Emulsion Polymerization

37 g sorbitan monooleate were dissolved in 160 g C₁₁-C₁₆ isoparaffin. 100 g water in a beaker were cooled to 5° C., then 50 g 2-acrylamido-2-methylpropane sulfonic acid and 10 g vinylphosphonic acid were added. The pH was adjusted to 7.1 with aqueous ammonia solution. Subsequently 268 g acryl amide solution (50 weight % in water) were added.

Under vigorous stirring the aqueous monomer solution was added to the isoparaffinic mixture. The emulsion was then purged for 45 min with nitrogen.

The polymerization was started by addition of 0.5 g azoisobutyronitrile in 12 g isoparaffin and heated to 50° C. To complete the reaction the temperature was increased to 80° C. and maintained at this temperature for 2 h. The polymer emulsion was cooled to room temperature. As product, a viscous fluid was obtained.

The K-value of was determined to be 390 as 0.1 wt.-% polymer solution in deionized water containing 0.5 wt.-% of an ethoxylated C₁₃ alcohol having a HLB of >10.

### Example 2

### Preparation of a Polymer Via Inverse Emulsion Polymerization

A polymer emulsion was prepared according to example 1 but using 58 g 2-acrylamido-2-methylpropane sulfonic acid 9.2 g acrylic acid and 245 g acryl amide solution (50 weight % in water). The K-value of this polymer determined as in Ex. 1 was 445.

### Example 3

### Preparation of a Polymer Via Gel Polymerization

400 ml deionized water and 15 ml 25 weight-% aqueous ammonia solution were placed in a reaction vessel. 20 g acryl amid solution (50 weight % in water), 30 g 2-acrylamido-2-methylpropane sulfonic acid, and 4 g vinylphoshonic acid were added under stirring. The solution was purged with nitrogen and heated to 50° C. The polymerization was started by addition of 5 ml of a 20% by weight aqueous solution of ammonium persulfate. To complete the reaction, the temperature was increased to 80° C. and maintained at this temperature for 2 h. After cooling to room temperature, a highly viscous gel was obtained. The gel was dried at 90° C. in a vacuum drying oven and carefully chopped from time to time. The dried polymer was crushed to obtain small particles. The K-value of this polymer determined as in Ex. 1 was 342.

### Example 4

### Preparation of a Polymer Via Gel Polymerization

A polymer was prepared according to example 3 but using 14 ml 25 weight-% aqueous ammonia solution, 30 g 2-acrylamido-2-methylpropane sulfonic acid, 4 g acrylic acid and 20 g acryl amide solution (50 weight % in water). The K-value of this polymer determined as in Ex. 1 was 460.

### Example 5 and 6

Crosslinking of the Polymers of Example 1 and 2 in Tap Water

In a commercially available Waring Blender, 0.4 g of isotridecanolethoxylate (6EO) were dissolved in 200 g of tap water by rapid mixing. Then 1.4 g of the polymer emulsion from Example 1 or 2, respectively, were injected into the funnel of the agitating container and agitated for 5 minutes. Linear gel viscosity was recorded at 100 rpm and room temperature using Fann 35 S Instrument. Then the pH of the fluid was adjusted to 4 to 5 with aqueous formic acid (21 wt.-%). 0.7 g of a zirconium (IV) crosslinker (20 wt.-%) was added drop wise and stirred for another 30 s to distribute the crosslinker homogeneously.

The gel was poured into the measuring cell of the Chandler 5550 rheometer flushed with argon and the viscosity was measured at a shear rate of 100 s⁻¹, at 25 bar and 93° C. (200° F.).

The viscosity results after 15, 30 and 45 min are shown in the table below.

| | | Linear gel (cP) | | | |
|---|---|---|---|---|---|
| | | viscosity at | Viscosity of crosslinked | | |
| | | 100 rpm | gel (cP) after x minutes | | |
| | | and room | at 100 s⁻¹ and 93° C. | | |
| Ex. | Polymer | temperature | 15 min | 30 min | 45 min |
| 5 | Example 1 | 18 | 238 | 220 | 211 |
| 6 | Example 2 | 17 | 11 | 10 | 10 |

### Example 7 and 8

Crosslinking of the Polymers of Example 3 and 4 in Tap Water

In a commercially available Waring Blender, 0.4 g of isotridecanolethoxylate (6EO) were dissolved in 200 g of tap water by rapid mixing. Then 0.4 g of the polymer from Example 3 or 4, respectively, were added into the funnel of the agitating container and agitated for 5 minutes. Linear gel viscosity was recorded at 100 rpm and room temperature using Fann 35 S Instrument. Then the pH of the fluid was adjusted to 4 to 5 with aqueous formic acid (21 wt.-%). 0.7 g of a zirconium (IV) crosslinker (20 wt.-%) was added drop wise and stirred for another 30 s to distribute the crosslinker homogeneously.

The gel was poured into the measuring cell of the Chandler 5550 rheometer flushed with argon and the viscosity was measured at a shear rate of 100 s⁻¹, at 25 bar and 93° C. (200° F.).

The viscosity results after 15, 30 and 45 min are shown in the table below.

| | | Linear gel (cP) | | | |
|---|---|---|---|---|---|
| | | viscosity at | Viscosity of crosslinked | | |
| | | 100 rpm | gel (cP) after x minutes | | |
| | | and room | at 100 s⁻¹ and 93° C. | | |
| Ex. | Polymer | temperature | 15 min | 30 min | 45 min |
| 7 | Example 3 | 17 | 75 | 66 | 64 |
| 8 | Example 4 | 20 | 11 | 9 | 9 |

The test results clearly show that polymers from examples 2 and 4 bearing carboxylic groups for crosslinking develop much lower viscosity when crosslinked using Zr-crosslinker.

### Example 9 and 10

Crosslinking of the Polymers of Example 1 and 2 in 2 wt.-% KCl Water

In a commercially available Waring Blender, 0.8 g of alkylpolyglucoside were dissolved in 200 g KCl water (2 wt.-%) by rapid mixing. Then 2.0 g of the polymer emulsion from Example 1 or 2, respectively, were injected into the funnel of the agitating container and agitated for 5 minutes. Linear gel viscosity was recorded at 100 rpm and room temperature using Fann 35 S Instrument. Then the pH of the fluid is adjusted to 4.5 to 4.8 with aqueous formic acid (21 wt.-%). 0.5 g of a zirconium (IV) crosslinker (20 wt.-%) was added drop wise and stirred for another 30 s to distribute the crosslinker homogeneously.

The gel was poured into the measuring cell of the Chandler 5550 rheometer flushed with argon and the viscosity was measured at a shear rate of 100 s⁻¹, at 25 bar and 93° C. (200° F.).

The viscosity results are shown in the table below.

| | | Linear gel (cP) | | | |
|---|---|---|---|---|---|
| | | viscosity at | | | |
| | | 100 rpm | Viscosity (cP) after x minutes | | |
| | | and room | at 100 s⁻¹ and 93° C. | | |
| Ex. | Polymer | temperature | 15 Min | 30 Min | 45 Min |
| 9 | Example 1 | 9 | 42 | 31 | 30 |
| 10 | Example 2 | 8 | 6 | 4 | 4 |

These results performed in water containing 2 wt-% KCl confirm that crosslinking via carboxylic groups do no build a viscous gel at conditions under examination.

### Examples 11 to Example 12

Friction Loop Tests in a Mini Loop System with 1/16″ Capillary

Place 500 ml 0.2 wt. % choline chloride water (clay stabilized water) into a beaker and stir at 750 rpm with a magnetic stirrer. Pump the water with a flow rate of 220 ml/min for two minutes and stop pumping in order to evaluate the system pressure (p₀).

Pump water with the flow rate 220 ml/min for two minutes to evaluate the pumping pressure generated with water without polymer and determine the water based pressure (p_{water}). Add 0.5 gpt polymer from Example 1 or Example 2 and pump the polymer solution with the same pumping rate for 10 minutes to determine the pressure induced by the polymer solution (p_{polymer,i}).

Flow Loop data: ⅙″ outer diameter, 1 mm inner diameter

For determination of friction reduction following formula was used:

$$FR \% - ( 1 - \frac{( {p}_{Polymer , i} - {\overline{p}}_{0} )}{( {\overline{p}}_{water} - {\overline{p}}_{0} )} ) * 100 \% with i - [ 1 … 600 ] sec$$

| | | FR % | | | |
|---|---|---|---|---|---|
| Example | Polymer | 10 sec | 20 sec | 30 sec | 60 sec |
| 11 | Example 1 | 22 | 21 | 23 | 25 |
| 12 | Example 2 | 19 | 19 | 21 | 25 |

The friction reduction increase of polymer from Example 1 is lower than the friction reduction increase of the polymer of Example 2, indicating a faster hydration of the polymer of Example 1.

### Examples 13 to 16

Friction Loop Tests in ½″ Flow Loop

Polymer emulsion of example 1 was mixed with 10% of an ethoxylated isotridecanol surfactant to obtain a fast inverting polymer emulsion.

Fresh water was pumped through the ½″ friction loop with 5 and 10 gpm (gallons per minute) and the pressure was recorded. Then, at a rate of 5 gpm, 0.5 gpt (gallons per thousand gallons) of the fast inverting polymer emulsion were added and the pressure was recorded after 5 min. The flow rate was then increased to 10 gpm and the pressure was recorded after 8 min. Then FR % was calculated according to the formula given in examples 11 and 12.

The test was then repeated using a commercially available friction reducer also adding 0.5 gpt to the fresh water.

The same test series was repeated using 3% CaCl₂ salt solution.

The results are given in the following table:

| | | | FR % | |
|---|---|---|---|---|
| | | | 5 gpm at | 10 gpm at |
| Example | Polymer | Water | 5 min | 8 min |
| 13 | Example 1 mixed | Fresh water | 64 | 65 |
| | with surfactant | | | |
| 14 | Commercial | Fresh water | 65 | 68 |
| | friction reducer | | | |
| 15 | Example 1 mixed | 3% CaCl₂ salt | 58 | 58 |
| | with surfactant | solution | | |
| 16 | Commercial | 3% CaCl₂ salt | 58 | 50 |
| | friction reducer | solution | | |

These results demonstrate that the polymer of example 1 shows good results a in friction reduction performance especially in divalent cation brine and can be compared with commercially available friction reducer. But as demonstrated in examples 5, 7, 9 the polymer can be crosslinked to provide high viscosity and stability and therefore good proppant carrier capability.

1. A method for subterranean treatment comprising the steps of:
(i) providing a treatment fluid containing at least
(I) water,
(II) a water soluble synthetic copolymer comprising acrylamide monomer units and additionally monomer units bearing phosphonic groups, said copolymer having not more than 5 wt. % of monomer units containing carboxylic groups,
(ii) adding optionally a breaker composition
(iii) pumping the treatment fluid into the formation,
(iv) adding polyvalent cation from the beginning of step (iii) or at a later time during step (iii), said polyvalent cation crosslinks the polymer chains and thereby increases the viscosity of the treatment fluid by forming a hydrogel,
(v) adding proppants to the treatment fluid from the beginning of step (iii) or at a later time during step (iii) or from the beginning of step (iv) or at a later time during step (iv).

2. The method as claimed in claim 1, wherein the quantity of the polymer for the non-crosslinked polymer solution in step (i) ranges from 0.001 to 10% by weight of a total mass of aqueous polymer solution

3. The method as claimed in claim 1, wherein the quantity of the polymer for the crosslinked polymer gel in step (iii) ranges from 0.01 to 10% by weight of a total mass of aqueous polymer solution.

4. The method as claimed in claim 1, wherein the K value of the synthetic polymer is greater than 300 determined as 0.1 weight % copolymer concentration in deionized water.

5. The method as claimed in claim 1, wherein the polymer is provided as a dispersion of solid particles in a water-immiscible liquid.

6. The method as claimed in claim 1, wherein the water soluble synthetic polymer material is a synthetic polymer comprising:
(I) at least structural units of formula (I) 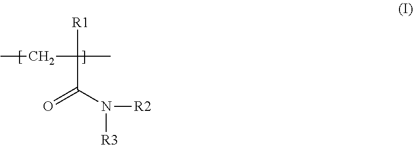
wherein
R1, R2 and R3 independently are hydrogen or C₁-C₆-alkyl,
(II) from 0 to 95% by weight structural units of formula (II) 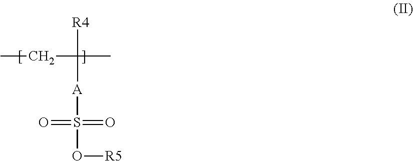
wherein
R4 is hydrogen or C₁-C₆-alkyl,
R5 is hydrogen, a cation of an alkaline metal, of an earth alkaline metal, of ammonia and/or of an organic amine,
A is a covalent C—S bond or a two-valent organic bridging group,
(III) from 0 to 5% by weight structural units of formula (III) 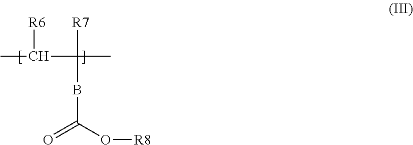
wherein
B is a covalent C—C bond or a two-valent organic bridging group
R6 and R7 are independently of one another hydrogen, C₁-C₆-alkyl, —COOR₉ or —CH₂—COOR₉, with R₉ being hydrogen, a cation of an alkaline metal, of an earth alkaline metal, of ammonia and/or of an organic amine,
R8 is hydrogen, a cation of an alkaline metal, of an earth alkaline metal, of ammonia and/or of an organic amine, or is C₁-C₆-alkyl, a group —CₙH₂ₙ—OH with n being an integer between 2 and 6, or is a group —CₒH₂ₒ—NR10R11, with o being an integer between 2 and 6, and
R10 and R11 are independently of one another hydrogen or C₁-C₆-alkyl, preferably hydrogen,
(IV) from 0 to 50% by weight structural units of formula (IV) 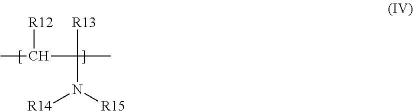
wherein
R12 and R13 are independently of one another hydrogen, C₁-C₆-alkyl, —COOR16 or —CH₂—COOR16, with
R16 being hydrogen, a cation of an alkaline metal, of an earth alkaline metal, of ammonia and/or of an organic amine,
R14 is hydrogen or, C₁-C₆-alkyl, and
R15 is —COH, —CO—C₁-C₆-alkyl or
R14 and R15 together with the nitrogen atom to which they are attached form a heterocyclic group with 4 to 6 ring atoms,
(V) from 0.1 to 20% by weight structural units of formula (V) 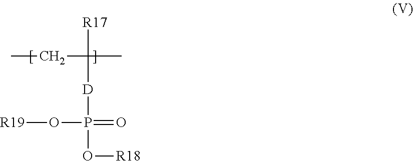
wherein
R17 is hydrogen or, C₁-C₆-alkyl, and
R18 and R19 are independently of one another hydrogen, a cation of an alkaline metal, of an earth alkaline metal, of ammonia and/or of an organic amine,
D is a covalent C—P bond or a two-valent organic bridging group,
(VI) optionally further copolymerisable monomers, such copolymerisable monomers being present from 0 to 20% by weight structural units,
with the proviso that the percentage of the structural units of formulae (I) to (VI), preferably the structural units of formulae (I) to (V), refer to the total mass of the copolymer and the percentage of the structural units of formulae (I) to (VI),

7. The method as claimed in claim 1, wherein the water soluble synthetic polymer material is selected from the group consisting of polymers containing:
(I) 10 to 90% by weight of structural formula I,
(II) 1 to 95% by weight of structural formula II,
(III) 0 to 2% by weight of structural formula III,
(IV) 0 to 50% by weight of structural formula IV,
(V) 0.1 to 20% by weight of structural formula V,
referred to the total mass of the polymer, with the proviso that the percentage of the structural units of formulae (I) to (V) refer to the total mass of the copolymer and the percentage of the structural units of formulae (I) to (V) amounts to 100%.

8. The method as claimed in claim 1 wherein the polyvalent cation is a multivalent metal ion or metal complex.

9. The method as claimed in claim 1 wherein a breaker composition is added in step (ii).

10. The method as claimed in claim 1 wherein the treatment fluid is injected as a fracturing fluid or to reduced friction pressure.

11. A fluid friction reducer for subterranean treatment containing at least:
(I) water,
(II) a water soluble synthetic copolymer comprising acrylamide monomer units and additionally monomer units bearing phosphonic groups, said copolymer having not more than 5 wt. % of monomer units containing carboxylic groups, said water soluble synthetic copolymer being cross-linkable using polyvalent cations, and
(III) optionally a breaker composition,
(IV) optionally at least one polyvalent cation,
(V) optionally at least one proppants
as friction reducer for subterranean treatment.

12. The method as claimed in claim 6, wherein the water soluble synthetic polymer material is selected from the group consisting of polymers containing:
(I) 10 to 90% by weight of structural formula I,
(II) 1 to 95% by weight of structural formula II,
(III) 0 to 2% by weight of structural formula III,
(IV) 0 to 50% by weight of structural formula IV,
(V) 0.1 to 20% by weight of structural formula V,
referred to the total mass of the polymer, with the proviso that the percentage of the structural units of formulae (I) to (V) refer to the total mass of the copolymer and the percentage of the structural units of formulae (I) to (V) amounts to 100%.

13. The method as claimed in claim 7 wherein the polyvalent cation is a multivalent metal ion or metal complex.

14. The method as claimed in claim 6 wherein a breaker composition is added in step (ii).

15. The method as claimed in claim 6 wherein the treatment fluid is injected as a fracturing fluid or to reduced friction pressure.
